(19) United States
(12) Patent Application Publication
(10) Pub. No.: US 2017/0169823 A1
(43) Pub. Date: Jun. 15, 2017

(54) Method and Apparatus for Voice Control of a Motor Vehicle

(71) Applicant: Bayerische Motoren Werke Aktiengesellschaft, Muenchen (DE)

(72) Inventor: Albrecht NEFF, Unterschleissheim (DE)

(21) Appl. No.: 15/378,842

(22) Filed: Dec. 14, 2016

(30) Foreign Application Priority Data
Dec. 15, 2015 (DE) 10 2015 225 305.8
Jan. 21, 2016 (DE) 10 2016 200 815.3

(51) Int. Cl. G10L 15/22; B60R 16/037; G10L 15/30

(52) U.S. Cl. CPC G10L 15/22; G10L 15/30; B60R 16/0373; G10L 2015/223; G10L 2015/228

(57) ABSTRACT

A method and apparatus for voice control of a motor vehicle are provided. A server external to the vehicle is set up for processing a voice command, for which purpose it can access non-vehicle-specific data, wherein the non-vehicle-specific data are stored in memory outside of the motor vehicle. The server is further set up for accessing vehicle-specific data to process the voice command. The motor vehicle has a voice input unit for input of a voice command by a user, particularly a driver of the motor vehicle, a communication unit for data communication with the server external to the vehicle, and a data acquisition unit for acquisition of vehicle-specific data. The method acquires a voice command via the voice input unit, transmits a voice file that represents the voice command by the communication unit to the server, acquires the vehicle-specific data by the data acquisition unit, transmits the vehicle-specific data by the communication unit to the server, and processes of the voice command.

### CROSS REFERENCE TO RELATED APPLICATIONS

This application claims priority under 35 U.S.C. §119 from German Patent Application No. 10 2015 225 305.8, filed Dec. 15, 2015, and 10 2016 200 815.3, filed Jan. 21, 2016, the entire disclosures of which are herein expressly incorporated by reference.

### BACKGROUND AND SUMMARY OF THE INVENTION

Voice control represents a possibility for facilitating operation of the diverse functions of a modern motor vehicle, which such a vehicle can have, for the driver. Two possibilities can fundamentally be differentiated for processing of voice input. On the one hand, processing of the voice input can take place in the vehicle, for example by means of a central control device of the vehicle. On the other hand, a data connection to a server external to the vehicle can be used, which server takes on the processing of the voice input. These two possibilities can also be combined.

DE 10 2012 213 668 A1 describes a method for operation of a voice-controlled data system for a vehicle. In this regard, at least one keyword is determined from a number of predetermined keywords, as a function of voice input by a vehicle user. Individual units of the data system can also be disposed outside of the vehicle. Current individual equipment of the vehicle can be taken into consideration in the determination of responses.

DE 10 2012 022 630 A1 teaches a method for communication of a driver with a driver assistance system. In this regard, recognition of catchwords is provided, which can also access external sources. For example, Internet servers, the databases of which are constantly updated, can be queried.

It is a disadvantage of the voice controls of the first type, mentioned initially (processing locally in the vehicle) that the number of voice commands that can be used is predetermined in a fixed manner. In particular, the voice control cannot react to commands for which it has no data. For example, the question: “What will the weather be tomorrow?” cannot be answered if no weather data are available.

The voice controls of the second type, mentioned initially (processing in a server external to the vehicle) do not have this disadvantage, because such a server can, by its nature, access a plurality of data sources to answer a question, for example over the Internet. However, these voice controls of the second type generally cannot access data that are present only locally in the vehicle in order to answer questions. For example, voice commands that relate to the current status of a driver assistance system of the vehicle cannot be processed. If a voice command is “How fast are we driving now?” for example, an answer to this cannot be determined without knowledge of the current vehicle speed.

Proceeding from the state of the art, the task arises of providing a voice control for motor vehicles, which has an improved scope of commands and improved flexibility.

This task is accomplished with a method and an apparatus in accordance with embodiments of the invention.

In the method according to the invention for voice control of a motor vehicle, a server external to the vehicle is set up for processing a voice command. The server external to the vehicle can be any server disposed outside of the vehicle. In particular, the server external to the vehicle can be an Internet server. The server external to the vehicle is set up for accessing non-vehicle-specific data for processing the voice command, with the non-vehicle-specific data being stored in memory outside of the motor vehicle. For example, the non-vehicle-specific data can be stored in a data memory of the server or at another location within a network accessible to the server, particularly on the Internet. The server external to the vehicle is furthermore set up for accessing vehicle-specific data to process the voice command. The motor vehicle includes a voice input unit for input of a voice command by a user, particularly by a driver of the motor vehicle. The motor vehicle furthermore includes a communication unit for data communication with the server external to the vehicle, as well as a data acquisition unit for acquisition of vehicle-specific data. The voice input unit can particularly be an interior space microphone of the motor vehicle. The communication unit can particularly be a data communication module of the motor vehicle, which is set up for wireless communication, for example by way of WLAN and/or by way of a mobile communication network (for example LTE, UMTS, etc.). The data acquisition unit can be a central control device of the motor vehicle, for example.

According to the invention, a voice command is acquired by the voice input unit. Subsequently, a voice file that represents the voice command is transmitted by the communication device to the server external to the vehicle. The voice file that represents the voice command can be generated from the analog voice signal acquired by the voice input unit, by way of digitalization (quantification, sampling, if applicable use of a voice codec), for example. Generation of the voice file can take place by the voice input unit, by the communication unit, or by way of another control device provided for this purpose.

According to the invention, the data acquisition unit acquires the vehicle-specific data. Subsequently, the vehicle-specific data are transmitted to the server by the communication unit. The server then processes the voice command.

The advantages of voice control in what is called the “backend” (in other words by a server external to the vehicle) can be utilized by means of the invention, while at the same time, voice control that requires knowledge of vehicle-specific data is simultaneously made possible.

It should be pointed out that the sequence selected in the description of the method steps according to the invention should not be understood as being restrictive. As will be explained in greater detail below, with reference to specific embodiments of the invention, individual method steps can be carried on in different sequences.

The term voice command should be interpreted broadly in connection with the present invention, and particularly comprises all voice input that the user of the motor vehicle could effect during use. In particular, the term voice command includes questions to which the user expects an answer. A simple example of such a question is: “Are there any traffic messages for our route?”

Furthermore, the term voice command comprises instructions that the user expects to be carried out. Embodiments of the invention can therefore provide that the voice command includes an instruction to control a vehicle function of the motor vehicle. Such an instruction can relate to control of a vehicle function that relates to driving operation of the motor vehicle. For example, a voice command could be: “Activate the cruise control at the current speed” or “Turn high beams on.” The instruction can also relate to control of vehicle functions that do not relate directly to driving operation of the motor vehicle. For example, the control command can relate to control of infotainment functions, comfort functions, and/or safety functions. For example, a voice command could be: “Increase the volume of the music output” or “Activate heated seats” or “Close all the windows.”

Furthermore, a voice command can comprise multiple individual voice commands. For example, a voice command could be: “Inform me about traffic messages and inform me about the weather at the destination.” This voice command, given as an example, comprises two different voice commands, namely “Inform me about traffic messages” and “Inform me about the weather at the destination.”

Likewise, it can be possible that a voice command comprises both questions and instructions, which can, of course, also be connected with one another in terms of content. For example, a voice command could be: “Open the convertible roof as long as there is no rain on the rest of the route.”

A voice command can also relate to reading out data from the motor vehicle. Such a voice command could be, for example: “What is our current speed?” or “What is the battery charge level?”

Furthermore, it can be provided that a voice command comprises a plurality of questions and/or instructions in terms of content. For example, the voice command “Safeguard the car” could include “Close all the windows,” “Close the sunroof,” “Turn the radio off,” as well as “Lock the car.” It is advantageous if such a voice command, which comprises a plurality of questions and/or instructions, is broken down by the server in terms of content.

The terms “vehicle-specific” and “non-vehicle-specific” should be understood, in the context of the present invention, as explained below. Vehicle-specific data are those data that are present in the sphere of the motor vehicle. Such data can be acquired by the data acquisition unit. In contrast, the server does not have vehicle-specific data until after they have been acquired by the data acquisition unit within the scope of the method according to the invention and transmitted to the server by the communication device. However, the term “vehicle-specific” should not be understood to mean that the data must have a direct connection, in terms of content, with the motor vehicle. For example, the ambient temperature of the motor vehicle, acquired by a temperature sensor of the motor vehicle, can be a vehicle-specific datum. Vehicle-specific data can also be stored in the memory of devices connected with the motor vehicle, for example on a smartphone connected with the motor vehicle by means of Bluetooth. This will be explained in greater detail below, with reference to an exemplary embodiment of the invention.

In contrast to this, non-vehicle-specific data are those data that are present in the sphere of the server. In particular, non-vehicle-specific data include those data to which the server has access by way of the Internet, for example. These include weather data, map data or traffic data, for example. The non-vehicle-specific data also include those data that relate to the motor vehicle, if the server has access to them—for example by way of the Internet. For example, the server could have access to a data server of the manufacturer of the motor vehicle, on which data relating to the motor vehicle are stored in memory. Furthermore, it is contemplated that data were acquired by the data acquisition unit during a past implementation of the method according to the invention and transmitted to the server by the communication unit. During a subsequent implementation of the method, these data (which were vehicle-specific data during the past implementation of the method) are non-vehicle-specific data.

Furthermore, it should be mentioned that the possibility exists for data to be present in the sphere of the motor vehicle and in the sphere of the server at the same time. For example, it is conceivable that data of the user are stored in memory on a smartphone, which is connected with the vehicle by way of a Bluetooth interface, for example. The data acquisition unit can directly access such data by way of Bluetooth. The data therefore lie in the sphere of the vehicle. At the same time, the smartphone can have an Internet connection independent of the vehicle. This can be a mobile communication connection or a WLAN connection, for example. The server can access data stored in the memory of the smartphone by way of this connection, independent of the vehicle. Such data are interpreted as vehicle-specific data, for the present invention, precisely when they are acquired by the data acquisition unit when the method according to the invention takes place. Accordingly, such data are interpreted as non-vehicle-specific data, for the present invention, precisely when they are directly acquired by the server or when the server accesses them directly.

The communication unit according to the invention can consist of multiple communication sub-units. For example, the motor vehicle can have a communication unit installed in the motor vehicle in a fixed manner, which unit can transmit and/or receive data both by way of a mobile communication network and by way of WLAN. In this example, the communication unit according to the invention can include not only the communication unit of the motor vehicle but also the mobile telephone connected with the motor vehicle by way of Bluetooth. For example, when the method according to the invention takes place, the voice file that represents the voice command can be transmitted to the server by the mobile telephone, whereas the vehicle-specific data are transmitted to the server by the communication unit of the motor vehicle.

In an advantageous embodiment, the step of acquisition of the vehicle-specific data by the data acquisition unit comprises acquisition of data by way of a data bus and/or a data interface of the motor vehicle. A data bus can be, for example, a CAN bus, MOST bus, FlexRay bus or Ethernet bus. For the purposes of the present invention, a data bus can also be a point-to-point connection from a control device of the motor vehicle to the data acquisition unit. A data interface of the motor vehicle can be an interface suitable for connecting digital devices with the motor vehicle, for example a wireless data interface (for example Bluetooth, WLAN, NFC) or a hard-wired data interface (for example USB). In that the data acquisition unit is set up for acquiring data by way of a data bus and/or a data interface of the motor vehicle, the data acquisition unit can access a major portion of the data that lie in the sphere of the motor vehicle.

To further advantage, it is provided, during the course of the method according to the invention, that the server requests certain vehicle-specific data as a function of the acquired voice command. These certain vehicle-specific data are then acquired by the data acquisition unit and transmitted to the server by the communication unit. This offers the advantage that first, the server evaluates the voice command, and it can be determined, as a function of the voice command, what (if applicable additional) vehicle-specific data are needed to process the voice command. In that these certain vehicle-specific data are requested by the server, the amount of vehicle-specific data to be transmitted is restricted to the certain vehicle-specific data actually needed and thereby kept low. Furthermore, in this way, the certain vehicle-specific data requested and necessary or helpful for processing the acquired voice command are up to date.

Furthermore, it can advantageously be provided that the server additionally requests the certain vehicle-specific data as a function of further information, data and/or prerequisites. For example, it can be provided that certain vehicle-specific data are requested as a function of the geographical position of the vehicle. If the vehicle is in a specific country, for example, traffic regulations, data privacy laws and/or other requirements that apply in this country can be taken into consideration when the server requests the certain vehicle-specific data.

Specific embodiments of the method according to the invention can advantageously provide that the steps of acquisition of the vehicle-specific data by the data acquisition unit and/or of transmission of the vehicle-specific data by the communication unit to the server take place independently of an acquired voice command and, in particular, at regular time intervals. Alternatively or in addition to the acquisition and/or the transmission of the vehicle-specific data at regular time intervals, it can be provided that these data are acquired and/or transmitted when predetermined events occur and/or when predetermined conditions are met. Such events or conditions can include activation or deactivation of specific vehicle functions or the existence of specific vehicle states.

The advantage of these embodiments consists in that the server already has the vehicle-specific data required for processing the transmitted voice command without having to especially request them. To particular advantage, it can be provided that the vehicle-specific data are acquired at regular intervals, but are only transmitted when the motor vehicle has a data connection to the server (for example WLAN) that is suitable for transmission of large amounts of data. The particular advantage of this embodiment consists in that a broadband and cost-advantageous data connection (for example WLAN in the user's garage) is used for transmission of large amounts of data (for example the collected vehicle-specific data), whereas a mobile communication connection with a lower data transmission rate, which is available during driving operation, is not burdened with the transmission of vehicle-specific data or only burdened to a slight extent.

Acquisition of the vehicle-specific data by the data acquisition unit can take place in that the data acquisition unit queries all the relevant vehicle-specific data at the corresponding data sources (for example control devices) (called polling). Alternatively or in addition, it can be provided that acquisition of the vehicle-specific data by the data acquisition unit proceeds from the data sources themselves, particularly from the control devices of the motor vehicle. This is particularly advantageous for those data sources for which the scope of vehicle-specific data that are relevant for the method according to the invention can change, as will still be explained below, with reference to further embodiments of the invention. Furthermore, acquisition of the vehicle-specific data by the data acquisition unit can take place in that the data acquisition unit evaluates the data stream on a data bus of the motor vehicle. In other words, the data acquisition unit “reads” the data traffic on the data bus.

In a further embodiment, the vehicle-specific data comprise possible and/or permissible voice commands. The vehicle-specific data are then therefore acquired in a form that is suitable for voice control. In other words, it can be provided that the motor vehicle informs the server what voice commands are possible and/or permissible in this motor vehicle. If the motor vehicle has a certain function (for example power windows), rather than the vehicle-specific data containing no data or just one datum about this specific function (for example: “power windows present”), the vehicle-specific data can, instead or in addition, also comprise voice commands that relate to this specific function (for example: “open windows,” “close windows”). For this purpose, it can be provided that the vehicle-specific data are transmitted to the data acquisition unit by the corresponding control devices of the motor vehicle, for example in the form of permissible and/or predetermined voice commands.

Alternatively or in addition, it can be provided that the server itself determines, on the basis of the vehicle-specific data, what voice commands are possible and/or permissible.

To further advantage, it can be provided that the scope of the possible and/or permissible voice commands or of the possible and/or permissible vehicle functions is dependent on a vehicle status. For example, specific voice commands can be available only when the motor vehicle is standing still or during automated driving operation of the motor vehicle. The information as to whether a voice command or a vehicle function is possible and/or permissible during a specific vehicle status can be determined by the motor vehicle itself (and subsequently transmitted to the server as a vehicle-specific datum), and/or can be determined by the server on the basis of the vehicle-specific data transmitted by the motor vehicle.

In a further embodiment, the vehicle-specific data relate to special equipment of the motor vehicle and/or to a status of a vehicle function of the motor vehicle and/or to a measured value of a sensor and/or to further data of the motor vehicle.

Special equipment can be, for example, convenience equipment and/or a function of the motor vehicle. Examples of special equipment of a motor vehicle can include:
power windows,
heated seats,
automatic climate control,
driver assistance systems,
infotainment systems.

Special equipment can also be added to or eliminated from existing motor vehicles. Manufacturers of motor vehicles can, for example, offer the user the possibility of acquiring or canceling specific functions of the motor vehicle, in the form of software updates. Such a software update can be installed on a central control device of the motor vehicle, for example. For example, the user of the motor vehicle could acquire a function and have it installed on the central control device, which function allows acquisition of specific vital parameters of the driver of the motor vehicle. The central control device could thereupon inform the data acquisition unit about the fact that it is set up for acquisition of specific vital parameters of the driver. Such a message could contain an indication of those vital parameters that the central control device can acquire (for example pulse, blood pressure).

Modern motor vehicles, also motor vehicles of a specific model or a specific series, can have an almost unmanageable number of different variants. This can be due to different series equipment or special equipment, different production data, different software, and the like. If these diverse data can be made available to the server that is external to the vehicle, as vehicle-specific data, this can advantageously increase the quality of the voice control.

A status of a vehicle function of the motor vehicle can, for example, comprise the information as to whether the vehicle function is activated or deactivated. A status of a vehicle function of the motor vehicle can also include a parameter of the vehicle function. For example, the status of the vehicle function climate control can include the desired interior space temperature that is set. A status of a vehicle function can furthermore include information that was created on the basis of the vehicle function having been carried out. For example, a status of a vehicle function can be the result of a self-diagnosis performed by the motor vehicle.

A measured value of the motor vehicle can include, for example:
an interior space temperature,
an outside temperature,
a current speed,
a geographical position,
measured values of the surroundings sensors, for example a distance from the car in front,
precipitation data,
a tire pressure.

The vehicle-specific data relating to special equipment of the motor vehicle, to a status of a vehicle function of the motor vehicle and/or to a measured value of a sensor of the motor vehicle can be acquired in that
the data acquisition unit queries them, and/or
the corresponding control devices transmit these data to the data acquisition unit, on their own, and/or
the data acquisition unit acquires these data by evaluating the data stream on a data bus of the motor vehicle.

Further data of the motor vehicle can include, for example:
data transmitted on a vehicle data bus, and/or
data stored in a data memory of the motor vehicle, particularly a data memory of a control device of the motor vehicle, and/or
results of a calculation internal to the vehicle, particularly data that are the result of processing of one or more measured values, and/or
commands and/or actions that can be carried out by the motor vehicle or by the vehicle function.

Advantageous embodiments can provide that a restriction of vehicle-specific data can be established on the vehicle side and/or on the server side. In this manner, data privacy needs or confidentiality needs of the vehicle user, for example, can be taken into consideration. For example, a driver could set that his/her current geographical position as well as his/her scheduling calendar, stored in a smartphone (connected with the motor vehicle), are not supposed to be transmitted to the server within the scope of the method according to the invention. It is understood that in this way, the voice control can be restricted in terms of its functional scope. It can be provided that this circumstance is pointed out to the user (“I cannot answer your question. I have no access to your current position.”).

To particular advantage, processing of the voice command by the server comprises determination of a response message, where the response message is transmitted to the communication unit by the server. The response message comprises a voice message, a control command and/or a test specification.

A voice message can comprise a spoken reply to the voice command. In this regard, it is unimportant whether the voice message is transmitted by the server directly to the communication unit (for example as a digital audio file) or whether the voice message transmitted by the server to the communication unit has a text form, for example, and still has to be converted to speech before voice output can occur.

A control command can be an instruction regarding control of a vehicle function of the motor vehicle, suitable for implementation by a control device of the motor vehicle, particularly by the central control device of the motor vehicle.

A test specification can contain one or more machine-readable and machine-executable program steps for checking conditions. A test specification can furthermore contain voice messages and/or control commands, which are output or carried out, or not, as a function of the outcome of checking a condition.

The test specification can be carried out by one or more control devices of the motor vehicle, particularly by the central control device. The central control device can access further control devices, if necessary, to carry out the test specification.

The response message can also comprise combinations of a voice message, control command, and test specification. In the following, it will be illustrated using two examples.

### EXAMPLE 1

A possible response message to a voice command: “Turn the vehicle light off” could read as follows (formulated in pseudocode):
1. Check ambient brightness.
2. If ambient brightness is greater than (predetermined value):
   Control command: “Light off.”
   Voice message: “The vehicle light was turned off.”
3. If ambient brightness is less than (predetermined value):
   Voice message: “Sorry, the vehicle light cannot be turned off because of the low ambient brightness.”

In this Example 1, let it be assumed that the predetermined value for ambient brightness (in parentheses in pseudocode) is known in the vehicle and/or in the server.

### EXAMPLE 2

In response to a voice command: “What is my distance from the car in front of me?” a possible response message could be the following:
1. Check whether radar sensor of the ACC function is active.
2. If radar sensor of the ACC function is not active:
   Activate radar sensor of the ACC function.
3. Check distance from the car in front in meters, by means of the measured values of the radar sensor.
4. Voice message: “The distance from the car in front is (distance) meters.”

In this Example 2, it is assumed that a “placeholder” is inserted into the voice message for the distance value determined (put in parentheses in pseudocode). In the voice output, the actual value is output.

The test specification in Example 2 first of all provides for checking whether the ACC (adaptive cruise control) function is active. This is necessary because the ACC function is accessed for measuring the distance from the car driving in front.

Preferred embodiments can provide that before a control command and/or a test specification is carried out, a check is performed as to whether the control command and/or the test specification is permissible. This check can preferably be carried out by the data acquisition unit (for example a central control device of the vehicle). For this purpose, it can particularly be provided that acquisition of the vehicle-specific data by the data acquisition unit comprises acquisition of those vehicle functions to which access by means of voice control is permitted. For safety reasons, it can be advantageous to draw up a positive list of all the vehicle functions that are accessible by voice control. Vehicle functions that are not included in the positive list are then not carried out. For these cases, a standardized message to the user can be provided, for example: “Sorry, this function cannot be operated by a voice command.” It can be provided that the vehicle user can adapt the positive list manually. In particular, the user can be given the possibility of prohibiting specific functions and/or data for the method according to the invention. In this way, a user's need for data privacy, for example, can be taken into account.

Particularly preferably, it can also be provided that specific vehicle functions can be accessed only after repeat confirmation by the user. For example, the server could transmit “Open all the windows” in response to the voice command “Open all the windows.” However, it can be provided that this control command is only output if the user confirms it (by means of voice control or by means of other operating elements) after the spoken request “Do you really want to open all the windows?” This additional checking step can be carried out locally in the vehicle. Alternatively, it can be provided by the server. In this case, it is transmitted as a test specification, as part of the response message.

The response message can furthermore comprise offering alternative options, to further advantage. This can be practical if the voice command stated by the user cannot be performed, but the server recognizes a practical alternative. For example, the voice command could be “Activate heated seats.” If the vehicle does not have heated seats, a response message could comprise the voice command: “Sorry, your vehicle does not have heated seats. Would you like to increase the interior space temperature?”

This example also makes it clear that the method can be carried out iteratively. It can therefore be provided that when the method is carried out more than a single time, vehicle-specific data are acquired and transmitted or response messages are transmitted by the server. In other words, a “dialog” between the server and the motor vehicle or the vehicle user can thereby come about. In this way, the server can check back with the user and can request that the user perform certain actions or confirmations.

It can happen that the server can interpret a voice command but cannot carry it out. Such voice commands could be carried out, under some circumstances, by an employee of a service center (call center) of the vehicle manufacturer. An example of this could be a request for reservations in a restaurant, theater or the like. It can be provided that in such a case, the server suggests or directly produces a voice connection with the service center.

Further embodiments can provide for the possibility of waking up the data acquisition unit and the communication unit for carrying out the method. This can be advantageous and necessary particularly when the vehicle is parked and turned off. In particular, the voice input unit can consist of a mobile telephone (smartphone) of the user, which is coupled with the vehicle. Examples of voice commands could be: “Do I still have to put gas in the car today for the trip home?”; “How long will I need for the trip home today?”; or “Please safeguard the car.” Such voice commands can then be carried out even when the vehicle is turned off. The data acquisition unit and the communication unit can, in turn, be set up for waking up control devices, sensors and/or actuators of the motor vehicle. This can take place, to particular advantage, as a function of the voice command.

It should be pointed out that the implementation of individual method steps of some embodiments of the method can take place with significant time intervals. For example, the voice command can comprise conditions where the server waits until they occur before transmitting a response message. Such voice commands could be, for example: “Please remind me to put gas in the car when I am 50 km away from the border,” “Please deactivate the heated seats in 5 minutes,” “Please let me know when the no-passing zone has ended” or “Please send my wife a SMS with the text ‘I will be there in 10 minutes’ as soon as I am only 10 minutes away from the navigation destination.”

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 a schematic arrangement of a motor vehicle having an apparatus according to the invention in an exemplary embodiment, as well as having an Internet server.

FIG. 2 a flow diagram of an exemplary embodiment of the method according to the invention.

### DETAILED DESCRIPTION OF THE DRAWINGS

It is pointed out that in the figures shown, as well as the related description, these are merely exemplary embodiments of the invention. In particular, representations of combinations of characteristics in the figures and/or in the figure description should not be interpreted to mean that the invention necessarily requires implementation of all the stated characteristics. Other embodiments of the invention can contain fewer, more and/or other characteristics. Furthermore, it is pointed out that the representations are fundamental representations of embodiments of the invention. The arrangement of the individual elements shown, relative to one another, is only selected as an example and can be selected differently in other embodiments of the invention.

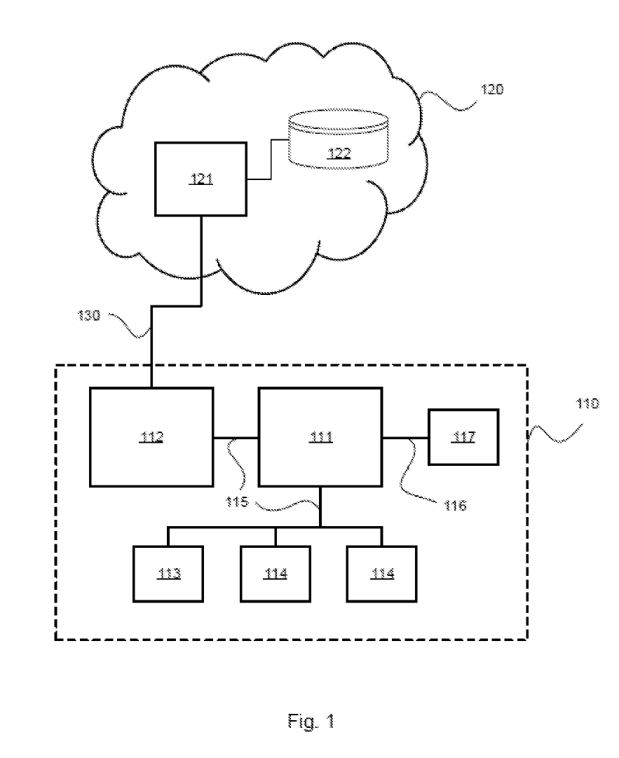

FIG. 1 shows a schematic arrangement of a motor vehicle 110 having an apparatus for voice control of the motor vehicle 110. The motor vehicle 110 has a data acquisition unit 111, a communication unit 112, a voice input unit 113, as well as further control devices 114. The data acquisition unit 111, the communication unit 112, the voice input unit 113, and the further control devices 114 are connected with one another by way of a data bus 115 of the motor vehicle 110. Furthermore, a mobile device 117 of the user is disposed in the motor vehicle 110. In particular, this can be a smartphone 117 of the user. The mobile device 117 is connected with the data acquisition unit 111 by way of a data interface 116. In particular, this can be a wireless data interface 116, for example a Bluetooth data interface 116.

The data acquisition unit 111 can be a central control device 111 of the motor vehicle 110. The communication unit 112 can be a telematics module 112 of the motor vehicle 110, which is set up for data communication by way of mobile communication networks (for example LTE, UMTS, etc.) and/or WLAN. The voice input unit 113 can be an interior space microphone of the motor vehicle 110. The voice input unit 113 can furthermore have a processing unit for generating the voice file that represents the voice command from the audio signal acquired by the interior space microphone. Generation of the voice file that represents the voice command can, however, also take place by way of another control device of the motor vehicle 110, for example by the data acquisition unit 111.

It should be pointed out that the arrangement shown in FIG. 1 should be understood to be an example. In particular, the arrangement could deviate from the arrangement shown in FIG. 1, in embodiments of the invention, in such a manner that the communication unit 112 and/or the voice input unit 113 are components of the mobile device 117 connected with the data acquisition unit 111. In other words, it can therefore be provided that the functionalities (voice acquisition, data communication) that are generally present in any case in a mobile device 117 are used to implement the invention.

The communication unit 112 of the motor vehicle 110 is set up for exchanging data with a server 121 external to the vehicle, on the Internet 120, by way of an Internet data connection 130, particularly a mobile communication connection or WLAN connection. The server 121 can be, for example, an Internet server 121 operated by a manufacturer of the motor vehicle 110. The server 121 commands or has access to a data memory 122, in which non-vehicle-specific data can be stored. In this regard, the representation in FIG. 1 should merely be understood schematically: A person skilled in the art knows that the server 121 has access to a great number of data sources 122 on the Internet 120.

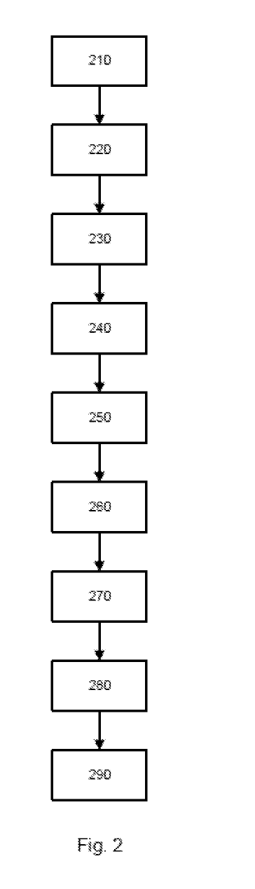

Using the flow diagram shown in FIG. 2, a method sequence used as an example will be explained in greater detail. In the first method step 210 shown in FIG. 2, vehicle-specific data are acquired by the data acquisition unit 111. The method step 210 can be initiated by the data acquisition unit 111. For this purpose, the data acquisition unit 111 can direct a query to some or all of the devices 112, 113, 114, 117 connected with it. The devices 112, 113, 114, 117 can transmit vehicle-specific data to the data acquisition unit 111 in response to the query transmitted by the data acquisition unit 111. In particular, each device can transmit a list containing the vehicle-specific data available on this device and suitable for use by voice control to the data acquisition unit 111. This is particularly advantageous with regard to the smartphone 117 of the user, which is connected with the data acquisition unit 111. A great number of application programs (apps) and data can be installed on this smartphone; their use as vehicle-specific data is desirable within the scope of the present invention. For example, a scheduling calendar of the user could be stored in the memory of the smartphone 117. In addition, further data regarding possible calendar events of the user could be present on the smartphone 117. For example, an app could be installed on the smartphone 117, which contains the program schedule of a specific theater. The vehicle-specific data transmitted by the smartphone 117 to the data acquisition unit 111 in step 210 could therefore include the data “Personal calendar” as well as “Events; Culture; Theater; Neustadt City Theater,” for example.

Furthermore, it should be mentioned that all the steps of acquisition of the vehicle-specific data by the data acquisition unit 111 (step 210 as well as step 260) can also provide that the data acquisition unit 111 “reads” the data that are transmitted on the data bus 115, in any case, and acquires the vehicle-specific data in this way.

The vehicle-specific data acquired in step 210 are transmitted to the server 121 by the communication unit 112 in the subsequent method step 220. It can be provided that not all the vehicle-specific data acquired in step 210 are transmitted in step 220, but rather the data acquisition unit 111 first makes a selection of the data to be transmitted. For example, the data acquisition unit 111 could be set up for selecting only newly added data for transmission, in other words those data that were not already transmitted to the server 121 during a past implementation of the method.

It should be pointed out that the method steps 210 and 220 are carried out independently of an acquired voice command. In particular, the method can provide that these steps are carried out at regular time intervals. Steps 210 and 220 can also be carried out whenever one of the devices 112, 113, 114, 117 connected with the acquisition unit has data that have not yet been acquired by the data acquisition unit 111 (if, for example, a new app is being installed on the smartphone 117), and the corresponding device is transmitting the vehicle-specific data not yet acquired in step 210 to the data acquisition unit 111, on its own.

In the method step 230, a voice command is acquired by the voice input unit 113. It shall be assumed, as an example, that the voice command is: “What play is on the schedule of the Neustadt City Theater tonight?”

In step 240, a voice file that represents the voice command is transmitted to the server 121 by the communication unit 112. The voice file that represents the voice command can have been previously generated from the audio signal recorded by the voice input unit 113 (for example by digitalization of the audio signal). Generation of the voice file can have taken place by way of the voice acquisition unit 113, the data acquisition unit 111 or the smartphone 117.

After the server 121 has received and evaluated the voice file, it can happen that the server does not have the data required for processing the voice command, and also cannot access them by way of the Internet. In the present example, let this be assumed for the program schedule of the Neustadt City Theater. However, the server 121 knows that the program schedule of the City Theater is available in the sphere of the motor vehicle 110 (namely on the smartphone 117), because this information was acquired in steps 210 and 220, as described above, and transmitted to the server 121.

The server 121 therefore needs certain vehicle-specific data for processing the voice command. In step 250, the server 121 requests these certain vehicle-specific data (namely the program schedule of the City Theater for this evening), in that it transmits a corresponding message to the communication unit 112 of the motor vehicle 110.

In step 260, it is provided that the data acquisition unit 111 acquires the certain vehicle-specific data. For this purpose, the data acquisition unit 111 directs a query to the smartphone 117 by way of the data interface 116. In this manner, the data acquisition unit 111 acquires the requested program schedule of the City Theater. In step 270, the certain vehicle-specific data (in other words the program schedule) are transmitted to the server 121 by the communication unit 112.

The server 121 now has all the data that it needs for processing the voice command. In step 280, this processing of the voice command takes place. In step 290, the server 121 transmits a response message, which is the result of processing of the voice command, to the communication unit 112. In the present example, the response message includes a voice message, for example “Tonight at 8 p.m., ‘As You Like It’ is being presented in the Neustadt City Theater.”

In an expansion of the example described, it would be conceivable that the voice command of the user additionally reads: “If tickets are still available, connect me with the service center of my vehicle manufacturer.” Checking whether tickets are still available is undertaken by the server 121, in that it expands the request for certain vehicle-specific data carried out in step 250 by the question regarding tickets still available for the requested performance. If it turns out that tickets are still available, the response message transmitted in step 290 can be expanded to include a corresponding voice message. The additional voice message reads, for example: “Tickets are still available. I will connect you with the service center.” The control command transmitted as part of the response message has an instruction to the central control unit 111 to establish a telephone connection with the service center of the vehicle manufacturer. The information that the motor vehicle 120 is set up for establishing telephone connections in the first place can be a part of the vehicle-specific data routinely acquired in step 210 and 220, as described above.

Alternatively, it would be conceivable, for example, that the voice command of the user additionally reads: “If tickets are still available, book tickets for me.” The server 121 checks, as described above, whether tickets are still available, in that it expands the request for vehicle-specific data performed in step 250 by the question concerning tickets that are still available for the queried performance. If it turns out that tickets are still available, however, the server is overtaxed by the voice command “Book tickets for me.” The additional voice message then reads, for example: “Tickets are still available. I will connect you with the service center” or “Tickets are still available. I cannot book them automatically and will therefore connect you with the service center.”

### REFERENCE SYMBOL LIST

110 motor vehicle
111 data acquisition unit
112 communication unit
113 voice input unit
114 control device
115 data bus
116 data interface
117 mobile device
120 Internet
121 server
122 data memory
130 Internet data connection
210-290 method steps

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for voice control of a motor vehicle, wherein
a server external to the motor vehicle is set up for processing a voice command, for accessing non-vehicle-specific data for processing the voice command, and for accessing vehicle-specific data to process the voice command, wherein the non-vehicle-specific data are stored in memory outside of the motor vehicle, and
the motor vehicle comprises a voice input unit for input of a voice command by a user, a communication unit for data communication with the server external to the vehicle, and a data acquisition unit for acquisition of vehicle-specific data, the method comprising the acts of:
acquiring a voice command via the voice input unit;
transmitting a voice file that represents the voice command by the communication unit to the server;
acquiring the vehicle-specific data by the data acquisition unit,
transmitting the vehicle-specific data by the communication unit to the server; and
processing the voice command.

2. The method according to claim 1, wherein the act of acquiring the vehicle-specific data by the data acquisition unit comprises acquiring data by way of a data bus and/or a data interface of the motor vehicle.

3. The method according to claim 1, further comprising the acts of:
requesting certain vehicle-specific data by the server as a function of the acquired voice command;
acquiring of the certain vehicle-specific data by the data acquisition unit; transmitting the certain vehicle-specific data by the communication unit to the server.

4. The method according to claim 1, wherein the acts of acquiring the vehicle-specific data by the data acquisition unit and transmitting the vehicle-specific data by the communication unit to the server take place independently of an acquired voice command.

5. The method according to claim 1, wherein the acts of acquiring the vehicle-specific data by the data acquisition unit and transmitting the vehicle-specific data by the communication unit to the server take place at regular time intervals.

6. The method according to claim 1, wherein the vehicle-specific data comprise possible and/or permissible voice commands.

7. The method according to claim 1, wherein the vehicle-specific data relate to special equipment of the motor vehicle, a status of a vehicle function of the motor vehicle, a measured value of a sensor of the motor vehicle and/or further data of the motor vehicle.

8. The method according to claim 1, wherein processing of the voice command comprises determining a response message by the server, and includes the act of:
transmitting the response message to the communication unit by the server,
wherein the response message comprises a voice message, a control command and/or a test specification.

9. An apparatus for voice control of a motor vehicle, comprising:
a voice input unit;
a communication unit; and
a data acquisition unit, wherein
the voice input unit is configured to acquire a voice command of a user of the motor vehicle,
the communication unit is configured to transmit a voice file representing the voice command to a server external to the vehicle,
the data acquisition unit is configured to acquire vehicle-specific data required for processing of the voice command by the server external to the vehicle, and
the communication unit is further configured to transmit the vehicle-specific data to the server.

10. A motor vehicle comprising an apparatus according to claim 9.

11. An apparatus for voice control of a motor vehicle comprising a voice input unit, a communication unit and a data acquisition unit, wherein the apparatus is configured to execute processing to:
acquire a voice command via the voice input unit;
transmit a voice file that represents the voice command by the communication unit to the server;
acquire the vehicle-specific data by the data acquisition unit,
transmit the vehicle-specific data by the communication unit to the server; and
process the voice command.
